(19) United States
(12) Patent Application Publication
(10) Pub. No.: US 2026/0185927 A1
(43) Pub. Date: Jul. 2, 2026

(54) SPECTRAL OVERLAY TARGET

(71) Applicant: KLA Corporation, Milpitas, CA (US)

(72) Inventors: Amnon Manassen, Haifa (IL); Mark Ghinovker, Yoqneam Ilit (IL); Eitan Hajaj, Ashqelon (IL); Suryanarayanan Ganesan, San Ramon, CA (US)

(21) Appl. No.: 19/005,410

(22) Filed: Dec. 30, 2024

(51) Int. Cl. G01N 21/21; G01N 23/2251

(52) U.S. Cl. CPC G01N 21/211; G01N 23/2251; G01N 2021/213; G01N 2201/127

(57) ABSTRACT

A metrology system including a measurement sub-system to collect zero-order double diffraction from a metrology target in response to an illumination beam, where the metrology target includes one or more grating-over-grating structures, having common pitches on two sample layers. The system may further include a controller to generate an after-develop inspection (ADI) metrology measurement of the metrology target at an ADI process step, generate an after-etch inspection (AEI) metrology measurement of the metrology target at an AEI process step, determine a non-zero offset (NZO) measurement based on a difference of the ADI metrology measurement and the AEI metrology measurement, and control one or more process tools based on at least one of the ADI metrology measurement, the AEI metrology measurement, or the NZO measurement.

### TECHNICAL FIELD

The present disclosure relates generally to overlay metrology and, more particularly, to an overlay metrology target measurable at different fabrication steps.

### BACKGROUND

Overlay (OVL) metrology continues to support Moore's law through an aggressive sampling roadmap. Increased sites per wafer are required for after-develop inspection (ADI) overlay control to facilitate higher order model corrections. Specifically, Correction Per Exposure (CPE) is increasingly utilized by customers, leading to more intra-field target measurements. However, a difference between an ADI overlay measurement on an overlay target and overlay on a device as measured or measurable at an after-etch inspection (AEI) step remains a critical issue with a high correlation to yield. This difference between target OVL in ADI and device OVL in AEI is referred to as non-zero offset (NZO) and is routinely calibrated using device OVL measurements in AEI. There is therefore a desire to develop systems and methods for improving overlay measurements.

### SUMMARY

In embodiments, the techniques described herein relate to a metrology system including an illumination source configured to generate an illumination beam; In embodiments, the metrology system includes a measurement sub-system including one or more lenses to direct the illumination beam to a sample when implementing a metrology recipe and collect zero-order double diffraction from a metrology target in response to the illumination beam, where the metrology target in accordance with the metrology recipe includes one or more grating-over-grating structures, where a particular one of the one or more grating-over-grating structures includes features with one or more common pitches on two sample layers. In embodiments, the measurement sub-system includes a detector to capture the zero-order double diffraction; and at least one of one or more polarizers or one or more phase control optics to manipulate at least one of the illumination beam or the zero-order double diffraction in accordance with the metrology recipe. In embodiments, the metrology system includes a controller including one or more processors configured to execute program instructions causing the one or more processors to implement the metrology recipe by generating an after-develop inspection (ADI) metrology measurement of the metrology target at an ADI process step based on ADI measurement data from the measurement sub-system generated at the ADI process step; generating an after-etch inspection (AEI) metrology measurement of the metrology target at an AEI process step based on using AEI measurement data from the measurement sub-system generated at the AEI process step; determining a non-zero offset (NZO) measurement based on a difference of the ADI metrology measurement and the AEI metrology measurement; and controlling one or more process tools based on at least one of the ADI metrology measurement, the AEI metrology measurement, or the NZO measurement.

In embodiments, the techniques described herein relate to a metrology system, where the program instructions further cause the one or more processors to generate an update of a sampling plan for future samples based on at least one of the ADI metrology measurement, the AEI metrology measurement, or the NZO measurement.

In embodiments, the techniques described herein relate to a metrology system, where the ADI measurement data is based on wavelengths equal to or greater than 400 nanometers, where the AEI measurement data is based on wavelengths equal to or greater than 150 nm.

In embodiments, the techniques described herein relate to a metrology system, where the ADI measurement data is based on wavelengths equal to or greater than 700 nanometers, where the AEI measurement data is based on wavelengths equal to or greater than 150 nm.

In embodiments, the techniques described herein relate to a metrology system, where the ADI measurement data is based on wavelengths equal to or greater than an absorption region of a material in the metrology target at the ADI process step, where the AEI measurement data is based on wavelengths equal to or less than the absorption region.

In embodiments, the techniques described herein relate to a metrology system, where the metrology target in accordance with the metrology recipe includes at least one of the one or more grating-over-grating structures having a fine pitch and a coarse pitch on each of the two sample layers, where the measurement sub-system is configured in accordance with the metrology recipe to generate the ADI measurement data based on the zero-order double diffraction associated with the coarse pitch and generate the AEI measurement data based on the zero-order double diffraction associated with the fine pitch.

In embodiments, the techniques described herein relate to a metrology system, where the fine pitch is less than 100 nanometers, where the coarse pitch is greater than 100 nanometers.

In embodiments, the techniques described herein relate to a metrology system, where the fine pitch is 50 nanometers, where the coarse pitch is 300 nanometers.

In embodiments, the techniques described herein relate to a metrology system, where the fine pitch is associated with segmentation of the coarse pitch.

In embodiments, the techniques described herein relate to a metrology system, where the coarse pitch is associated with modulation of widths of features with the fine pitch.

In embodiments, the techniques described herein relate to a metrology system, where the coarse pitch is associated with optical parameter correction (OPC) features.

In embodiments, the techniques described herein relate to a metrology system, where the one or more grating-over-grating structures of the metrology target include one or more first grating-over-grating structures with a first fine pitch and a first coarse pitch along a first measurement direction; and one or more second grating-over-grating structures with a second fine pitch and a second coarse pitch along a second measurement direction, where the measurement sub-system generates the ADI measurement data and the AEI measurement data by simultaneously illuminating the one or more first grating-over-grating structures and the one or more second grating-over-grating structures with the illumination beam, where the ADI metrology measurement and the AEI metrology measurement correspond to both the first measurement direction and the second measurement direction.

In embodiments, the techniques described herein relate to a metrology system, where the first fine pitch, the second fine pitch, the first coarse pitch, and the second coarse pitch are selected to provide that the zero-order double diffraction associated with the one or more first grating-over-grating structures is separable by the controller from the zero-order double diffraction from the one or more second grating-over-grating structures.

In embodiments, the techniques described herein relate to a metrology system, where the metrology target in accordance with the metrology recipe includes one of the one or more grating-over-grating structures having single common pitch on each of the two sample layers, where the measurement sub-system is configured in accordance with the metrology recipe to generate the ADI measurement data using a first spectrum of the illumination beam and generate the AEI measurement data with a second spectrum of the illumination beam, where the second spectrum of the illumination beam includes one or more wavelengths smaller than the first spectrum.

In embodiments, the techniques described herein relate to a metrology system, where the one or more process tools include at least one of a lithography tool, an etching tool, or a polishing tool.

In embodiments, the techniques described herein relate to a metrology system, where the measurement sub-system includes at least one of an ellipsometer, a reflectometer, or a scatterometer.

In embodiments, the techniques described herein relate to a metrology system, where the measurement sub-system includes a spectral ellipsometer.

In embodiments, the techniques described herein relate to a metrology system, where at least one of the ADI metrology measurement or the AEI metrology measurement is calibrated based on measurement data of one or more measurements of additional metrology targets with an additional metrology tool.

In embodiments, the techniques described herein relate to a metrology system, where the additional metrology tool includes a scanning electron microscope.

In embodiments, the techniques described herein relate to a metrology method including generating, with a measurement sub-system including one or more lenses to direct illumination to a metrology target and collect zero-order light from the metrology target, an after-develop inspection (ADI) metrology measurement using ADI measurement data associated with zero-order double diffraction from the metrology target at an ADI process step, where the metrology target includes one or more grating-over-grating structures, where a particular one of the one or more grating-over-grating structures includes features with one or more common pitches on two sample layers. In embodiments, the method includes generating, with the measurement sub-system, an after-etch inspection (AEI) metrology measurement using AEI measurement data associated with zero-order double diffraction from the metrology target at an AEI process step. In embodiments, the method includes determining a non-zero offset (NZO) measurement based on a difference of the ADI metrology measurement and the AEI metrology measurement. In embodiments, the method includes controlling one or more process tools based on at least one of the ADI metrology measurement, the AEI metrology measurement, or the NZO measurement.

In embodiments, the techniques described herein relate to a metrology method, where at least one of the ADI metrology measurement or the AEI metrology measurement is calibrated based on measurement data of one or more measurements of additional metrology targets.

In embodiments, the techniques described herein relate to a metrology method, further including updating a sampling plan for future samples based on at least one of the ADI metrology measurement, the AEI metrology measurement, or the NZO measurement.

In embodiments, the techniques described herein relate to a metrology method, where the ADI measurement data is based on wavelengths equal to or greater than 400 nanometers, where the AEI measurement data is based on wavelengths equal to or greater than 150 nm.

In embodiments, the techniques described herein relate to a metrology method, where the ADI measurement data is based on wavelengths equal to or greater than 700 nanometers, where the AEI measurement data is based on wavelengths equal to or greater than 150 nm.

In embodiments, the techniques described herein relate to a metrology method, where the ADI measurement data is based on wavelengths equal to or greater than an absorption region of a material in the metrology target at the ADI process step, where the AEI measurement data is based on wavelengths equal to or less than the absorption region.

In embodiments, the techniques described herein relate to a metrology method, where the metrology target includes at least one of the one or more grating-over-grating structures having a fine pitch and a coarse pitch on each of the two sample layers, where the ADI measurement data is associated with the coarse pitch and the AEI measurement data is associated with the fine pitch.

In embodiments, the techniques described herein relate to a metrology method, where the fine pitch is less than 100 nanometers, where the coarse pitch is greater than 100 nanometers.

In embodiments, the techniques described herein relate to a metrology method, where the fine pitch is 50 nanometers, where the coarse pitch is 300 nanometers.

In embodiments, the techniques described herein relate to a metrology method, where the fine pitch is associated with segmentation of the coarse pitch.

In embodiments, the techniques described herein relate to a metrology method, where the coarse pitch is associated with modulation of widths of features with the fine pitch.

In embodiments, the techniques described herein relate to a metrology method, where the coarse pitch is associated with optical parameter correction (OPC) features.

In embodiments, the techniques described herein relate to a metrology method, where controlling the one or more process tools based on at least one of the ADI metrology measurement, the AEI metrology measurement, or the NZO measurement includes controlling at least one of a lithography tool, an etching tool, or a polishing tool based on at least one of the ADI metrology measurement, the AEI metrology measurement, or the NZO measurement.

In embodiments, the techniques described herein relate to a metrology method, where the measurement sub-system includes at least one of an ellipsometer, a reflectometer, or a scatterometer.

In embodiments, the techniques described herein relate to a metrology method, further including designing the metrology target by selecting the one or more common pitches based on a known wavelength range of a measurement sub-system and one or more known properties of the metrology target at the ADI process step and the AEI process step.

In embodiments, the techniques described herein relate to a metrology target including one or more grating-over-grating structures, where a particular one of the one or more grating-over-grating structures includes first-layer features on a first layer of a sample; and second-layer features on a second layer of the sample overlapped with the first-layer features, where the first-layer features and the second-layer features have one or more common pitches, where the one or more common pitches are selected in accordance with a metrology recipe to provide that zero-order double diffraction from the first-layer features and the second-layer features is measurable when the metrology target is embodied at an after-develop inspection (ADI) process step by a metrology tool and are further selected in accordance with the metrology recipe to provide that zero-order double diffraction from the first-layer features and the second-layer features is measurable when the metrology target is embodied at an after-etch inspection (AEI) process step by the metrology tool.

In embodiments, the techniques described herein relate to a metrology target, where the one or more common pitches include a fine pitch and a coarse pitch, where the coarse pitch is selected in accordance with the metrology recipe to provide that the zero-order double diffraction from the first-layer features and the second-layer features is measurable when the metrology target is embodied at the ADI process step by the metrology tool, where the fine pitch is selected in accordance with the metrology recipe to provide that the zero-order double diffraction from the first-layer features and the second-layer features is measurable when the metrology target is embodied at the AEI process step by the metrology tool.

In embodiments, the techniques described herein relate to a metrology target, where the fine pitch is less than 100 nanometers, where the coarse pitch is greater than 100 nanometers.

In embodiments, the techniques described herein relate to a metrology target, where the fine pitch is 50 nanometers, where the coarse pitch is 300 nanometers.

In embodiments, the techniques described herein relate to a metrology target, where the fine pitch is associated with segmentation of the coarse pitch.

In embodiments, the techniques described herein relate to a metrology target, where the coarse pitch is associated with modulation of widths of the first-layer features and the second-layer features.

In embodiments, the techniques described herein relate to a metrology target, where the coarse pitch is associated with optical parameter correction (OPC) features.

In embodiments, the techniques described herein relate to a metrology target, where the one or more grating-over-grating structures of the metrology target include one or more first grating-over-grating structures with a first fine pitch and a first coarse pitch along a first measurement direction; and one or more second grating-over-grating structures with a second fine pitch and a second coarse pitch along a second measurement direction.

In embodiments, the techniques described herein relate to a metrology target, where the first fine pitch, the second fine pitch, the first coarse pitch, and the second coarse pitch are selected to provide that the zero-order double diffraction associated with the one or more first grating-over-grating structures is separable from the zero-order double diffraction from the one or more second grating-over-grating structures.

In embodiments, the techniques described herein relate to a metrology target, where the one or more common pitches include a single common pitch, where the single common pitch is selected in accordance with the metrology recipe to provide that the zero-order double diffraction from the first-layer features and the second-layer features is measurable when the metrology target is embodied at the ADI process step by the metrology tool using a first wavelength, where the single common pitch is selected in accordance with the metrology recipe to provide that the zero-order double diffraction from the first-layer features and the second-layer features is measurable when the metrology target is embodied at the AEI process step by the metrology tool using a second wavelength.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A illustrates a simplified side view of a metrology target embodied at an after-develop inspection (ADI) process step, in accordance with one or more embodiments of the present disclosure.

FIG. 1B illustrates a simplified side view of the metrology target embodied at an after-etch inspection (AEI) process step, in accordance with one or more embodiments of the present disclosure.

FIG. 1C illustrates a simplified side view of a metrology target, in accordance with one or more embodiments of the present disclosure.

FIG. 1D illustrates a top view of a metrology target including a grating-over-grating structure in which multiple periodicities are provided through critical dimension (CD) modulation, in accordance with one or more embodiments of the present disclosure.

FIG. 1E illustrates a top view of a metrology target including a grating-over-grating structure in which multiple periodicities are provided through optical proximity correction (OPC) feature modulation, in accordance with one or more embodiments of the present disclosure.

FIG. 1F illustrates a top view of a metrology target providing two grating-over-grating structures with periodicities along different measurement directions, in accordance with one or more embodiments of the present disclosure.

FIG. 1G illustrates a top view of a metrology target providing multiple grating-over-grating structures associated with each measurement direction, in accordance with one or more embodiments of the present disclosure.

FIG. 2A illustrates zero-order double-diffraction from grating-over-grating structures based on evanescent wave double scattering, in accordance with one or more embodiments of the present disclosure.

FIG. 2B illustrates zero-order double-diffraction from grating-over-grating structures for configurations with larger separations between sample layers than depicted in FIG. 2A, in accordance with one or more embodiments of the present disclosure.

FIG. 3 depicts simulations of overlay sensitivity for a metrology target at different process steps, in accordance with one or more embodiments of the present disclosure.

FIG. 4A is a block diagram of a metrology system in accordance with one or more embodiments of the present disclosure.

FIG. 4B is a simplified schematic of an optical measurement sub-system, in accordance with one or more embodiments of the present disclosure.

FIG. 5 is a flow diagram illustrating steps performed in a metrology method, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing metrology on a common metrology target suitable at both an after-develop inspection (ADI) step and an after-etch inspection (AEI) step in a fabrication process with a common metrology measurement system suitable for high volume manufacturing operations such as, but not limited to, an optical metrology system capturing zero-order double diffraction.

As used herein, zero-order double diffraction refers to light that interacts with a grating-over-grating structure through double diffraction of evanescent waves by both top and bottom layer features, which emanates from the grating-over-grating at a reflection angle. It is contemplated herein that such zero-order double diffraction may include “coded” phase information associated with the grating-over-grating structure, even if the features themselves are not resolved by the optical system. As a result, various metrology measurements may be extracted from zero-order double diffraction signals including, but not limited to, overlay measurements, asymmetry measurements (e.g., tilt measurements, or the like), film thickness measurements, or critical dimension (CD) measurements.

In embodiments, a metrology target includes features having grating-over-grating (GoG) structures in two sample layers (e.g., a top layer and a bottom layer), where the features on both the top layer and the bottom layer both include features with one or more common pitches, where the one or more pitches are designed to enable metrology measurements with a common optical metrology system when embodied in both the ADI and AEI steps of the fabrication process. For example, an overlay target embodied at an ADI process step may include process features on one sample layer and resist features on another sample layer, whereas the same overlay target embodied at an AEI process step may include process features on two sample layers. It is contemplated herein that although this overlay target may have the same one or more pitches when embodied at the ADI and AEI process steps, other structural differences such as, but not limited to, the number or separation of layers in the metrology may impact the conditions under which zero-order double diffraction may be coded with information indicative of a metrology measurement. Accordingly, a metrology target may be designed to enable metrology measurements using a common metrology tool using a common metrology technique (e.g., ellipsometry, reflectometry, scatterometry, or the like) at both ADI and AEI process steps. In some cases, the target includes GoG structures with multiple pitches (e.g., segmented structures, or the like) such that ADI metrology data may be based on one pitch and the AEI metrology data may be based on another pitch. In some cases, the target includes GoG structures with a single pitch designed such that ADI measurements may be performed with one spectrum (one or more selected wavelength) and AEI measurements may be performed with another spectrum (e.g., one or more different wavelengths).

It is contemplated herein that measuring a common overlay target with a common metrology system at different process steps (e.g., ADI and AEI) may provide highly-accurate non-zero offset (NZO) measurements. In particular, the NZO measurements disclosed herein may be devoid of location or measurement technology variabilities that otherwise result in errors associated with alternative NZO measurement techniques based on measurements of different targets at different locations of a sample. This capability is crucial for achieving consistent and accurate metrology metrics, which are essential for process control and optimization in semiconductor fabrication.

The systems and methods disclosed herein further provide solutions to overcome practical challenges for NZO measurements. The perceived NZO quality may be inversely proportional to its magnitude, which is typically proportional to a difference between pitches associated with fabricated devices (e.g., device pitch) and pitches associated with a metrology target (e.g., target pitch). It may thus be desirable to have an ADI target with the smallest possible pitch. In resolved optical systems, measurement of a smaller pitch requires a wavelength of similar magnitude. For example, measuring a target with 400 nm pitch requires the use of blue wavelengths. However, blue wavelengths are not an optimal choice due in many applications to the presence of etch control hard mask layers that are opaque in this wavelength range. It may then be desirable to enable measurement of a relatively small-pitch ADI target with relatively longer wavelengths for which the hard masks layers are transparent (e.g., wavelengths greater than blue, red wavelengths, or the like).

Some current approaches involve Moiré effects generated by grating-over-grating targets that have different pitches on top and bottom layers. However, this pitch difference between layers of a metrology target may cause mechanical stability issues and process challenges in some applications. In contrast, systems and methods disclosed herein utilize a metrology target with grating-over-grating structures having common pitches in top and bottom sample layers, which provides mechanical stability. Both ADI and AEI measurements may be performed on the same metrology target using any combination of different wavelength ranges or multiple pitches (on both top and bottom layers). For example, relatively higher wavelengths may be used in an ADI step (e.g., those outside an absorption region of a hard mask layer if present) and relatively lower wavelengths may be used in an AEI step. As another example, a coarse pitch (common to both the top and bottom layers) may be used as the basis of a measurement in an ADI step and a fine pitch (also common to both the top and bottom layers) may be used as the basis of a measurement in an AEI step, where the same or different wavelengths are used in the ADI and AEI steps as suitable.

The resulting NZO measurements can also be directly used or serve as a reference for correcting other measurement methodologies, thereby offering a robust solution for improving overlay accuracy and process yield.

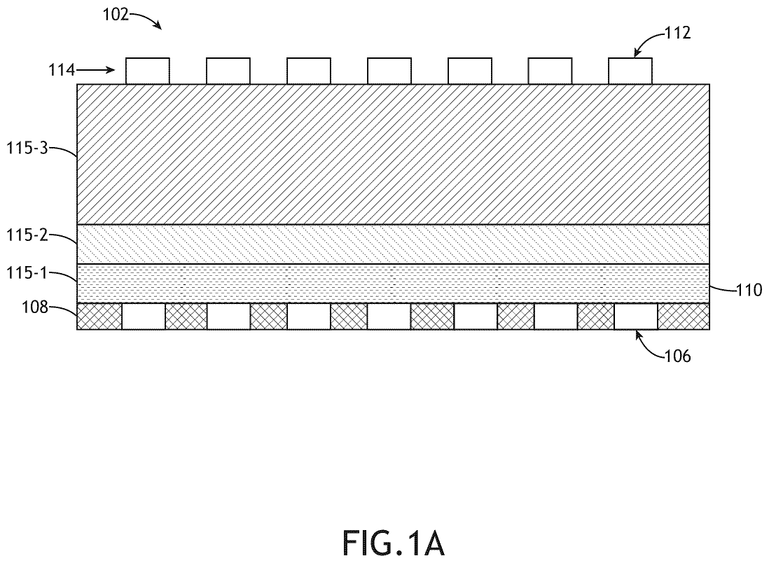

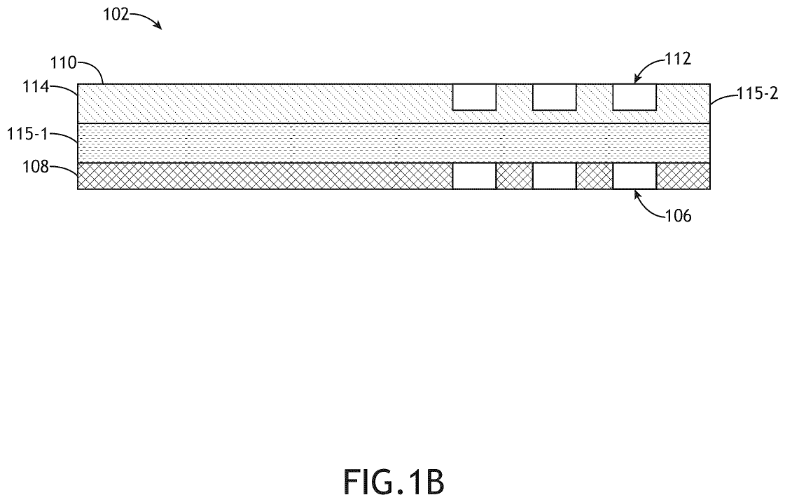

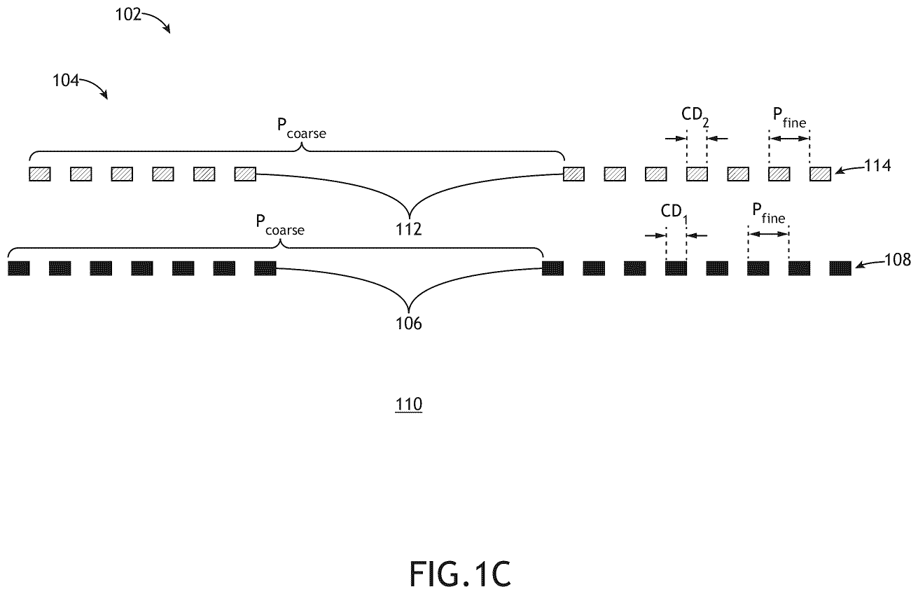

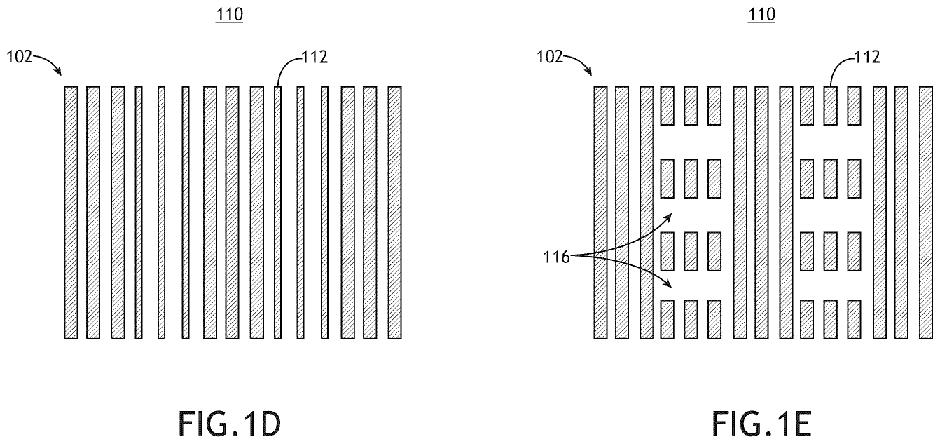

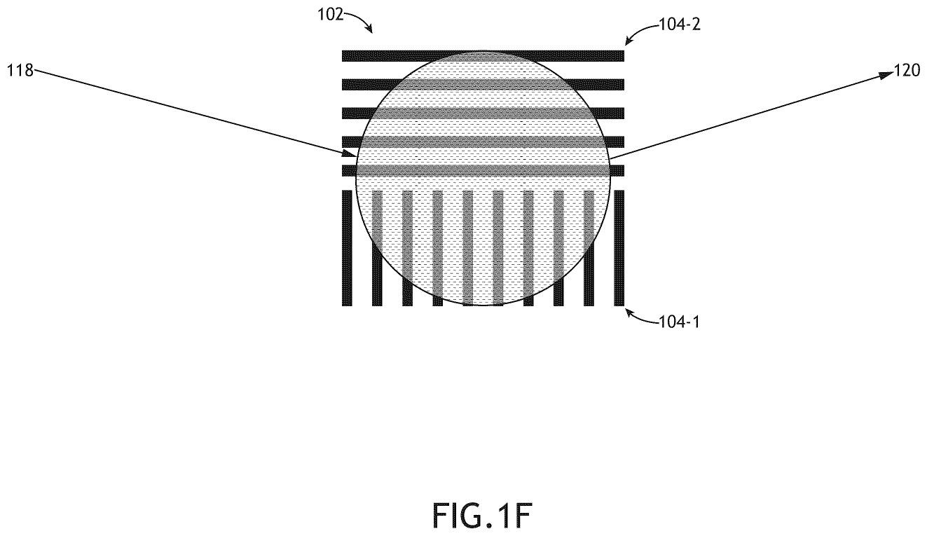

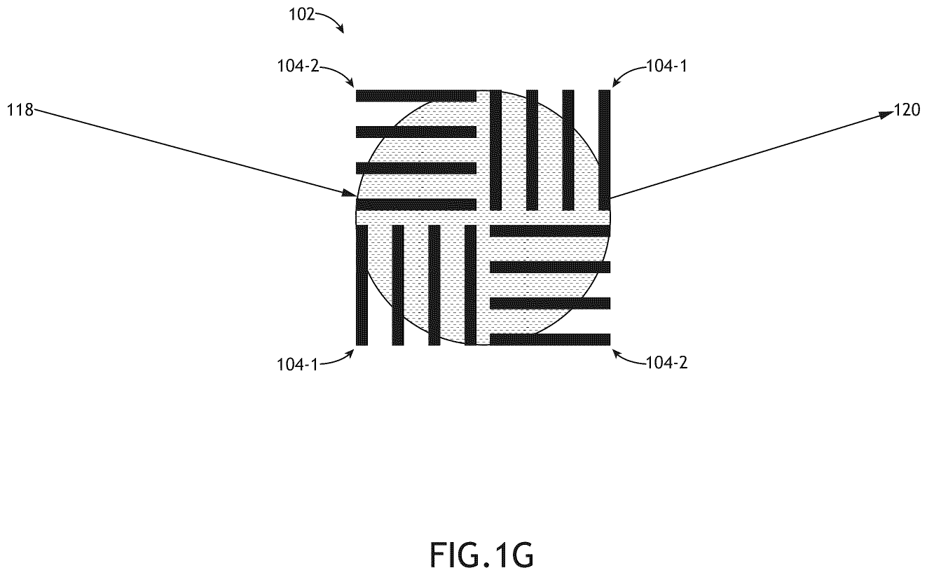

Referring now to FIGS. 1A-5, systems and methods providing metrology measurements on a common overlay target at multiple process steps, in accordance with one or more embodiments of the present disclosure.

FIGS. 1A-1B depict a metrology target 102 embodied at two different process steps, in accordance with one or more embodiments of the present disclosure. As used herein, a process step may correlate to any step of a fabrication process such as, but not limited to, a semiconductor fabrication process. For example, process steps may include, but are not limited to, material deposition steps, lithography steps, etching steps, or polishing steps.

FIG. 1A illustrates a simplified side view of a metrology target 102 embodied at an ADI process step, in accordance with one or more embodiments of the present disclosure. FIG. 1B illustrates a simplified side view of the metrology target 102 embodied at an AEI process step, in accordance with one or more embodiments of the present disclosure.

In some embodiments, a metrology target 102 includes a grating-over-grating structure 104 formed with first-layer features 106 on a first layer 108 of a sample 110 (e.g., a bottom layer) and second-layer features 112 on a second layer 114 of the sample 110 (e.g., a top layer), where the first-layer features 106 and the second-layer features 112 at least partially overlap (e.g., when viewed from the top). The first-layer features 106 and the second-layer features 112 may have one or more common pitches, which may provide that double diffraction from the first-layer features 106 and second-layer features 112 emanates from the grating-over-grating structure 104 at an angle associated with other zero-order light such as reflected light, zero-order diffraction, or the like.

As shown in FIGS. 1A-1B, the metrology target 102 may have different physical characteristics when embodied at different process steps. For example, FIG. 1A depicts first-layer features 106 as process features (e.g., features formed on patterned layers from a previous process step), the second-layer features 112 as resist features (e.g., features formed from photoresist), and multiple additional layers (layer 115-1, layer 115-2, and layer 115-3) between the first layer 108 and the second layer 114 (e.g., as intermediate layers). However, FIG. 1B depicts the second-layer features 112 as process features associated with patterned structures in the layer 115-1, which are formed through a series of etching and polishing steps. The various layers of the metrology target 102 embodied at either the ADI or AEI process steps may be formed from any material or combinations of materials. For example, the metrology target 102 may include a hardmask layer (e.g., layer 115-3, or the like) in an ADI step that is fully or partially removed at the AEI process step. However, this is merely and illustration is not limiting. As another example, a metrology target 102 embodied at an AEI step may be formed with both the first-layer features 106 and the second-layer features 112 as process features.

The pitches of the first-layer features 106 and the second-layer features 112 may remain the same when the metrology target 102 is embodied at both the ADI and AEI process steps. In this way, the terms first layer 108, second layer 114, or the like (e.g., additional layers 115-1, 115-2, 115-3, or other layers not shown) are used herein as relative terms rather than restrictive of any particular physical layer on the sample 110.

The first-layer features 106 and the second-layer features 112 may have any pitch or combination of pitches suitable for measurement by any selected wavelengths at both the ADI and AEI process steps, where it is understood that the different physical characteristics of the metrology target 102 when embodied at the ADI and AEI process steps may differ.

In some embodiments, the first-layer features 106 and the second-layer features 112 have a single common pitch designed to satisfy requirements for encoding metrology information into zero-order double diffraction based when embodied in multiple process steps such as, but not limited to, ADI and AEI steps. For example, the metrology target 102 may be characterized at an ADI process step by a metrology tool at one wavelength or spectral range and characterized at an AEI process step by the same metrology tool at another wavelength or spectral range. As an illustration in a case where the metrology target 102 includes a hardmask at an ADI process step, the metrology target 102 may be characterized at an ADI process step by a metrology tool at a wavelength or spectral range suitable for propagating through the hardmask (e.g., at least partially transparent to the hardmask). It is understood that different hardmask materials may have different absorption properties. In some applications, the metrology target 102 is designed to be characterized in an ADI process step at wavelengths greater than 400 nm. In some applications, the metrology target 102 is designed to be characterized in an ADI process step at wavelengths greater than 700 nm. Further, the same metrology target 102 may be characterized at an AEI process step by a metrology tool at a second wavelength or spectral range, potentially with lower wavelengths. Continuing the example above, the removal of the hardmask by the AEI process step may enable the use of wavelengths or spectral ranges at an AEI process step that would otherwise be absorbed by the hardmask (e.g., wavelengths lower than 400 nm, or higher wavelengths as desired).

It is to be understood that the example of the hardmask is merely an illustration and nonlimiting. The metrology target 102 may have any materials or combinations of materials at the ADI and AEI process steps. Further, any selection of common pitches in the metrology target 102 and/or characterization wavelengths may be utilized.

In some embodiments, the first-layer features 106 and the second-layer features 112 have at least two different pitches (e.g., two different periodicities) designed to satisfy requirements for encoding metrology information into zero-order double diffraction based when embodied in multiple process steps such as, but not limited to, ADI and AEI steps. For example, a metrology tool may generate measurement data for the metrology target 102 at an ADI process step associated with one pitch and may generate measurement data for the metrology target 102 at an AEI process step associated with another pitch. In this configuration, the metrology tool may use the same or different wavelengths or spectral ranges for the measurements at the ADI and AEI process steps.

Different periodicities in the grating-over-grating structures 104 may be provided using various designs.

FIG. 1C illustrates a simplified side view of a metrology target 102, in accordance with one or more embodiments of the present disclosure. In some embodiments, as illustrated in FIG. 1C, the first-layer features 106 and the second-layer features 112 include are distributed into groupings separated by a coarse pitch P_{coarse}, where the groupings are segmented with a fine pitch P_{fine}. For example, the fine pitch P_{fine} may correspond to a pitch of at least some device features being fabricated on the sample (e.g., memory devices, logic devices, or the like) such that the fine pitch may be characterized as a device pitch.

FIG. 1D illustrates a top view of a metrology target 102 including a grating-over-grating structure 104 in which multiple periodicities are provided through CD modulation, in accordance with one or more embodiments of the present disclosure. For the purposes of clarity, only the second-layer features 112 on the second layer 114 (e.g., the top layer) of the sample 110 are depicted. In FIG. 1D, the first-layer features 106 and the second-layer features 112 are distributed with a fine pitch P_{fine}, where the CDs of individual features are modulated into groupings separated by a coarse pitch P_{course}.

FIG. 1E illustrates a top view of a metrology target 102 including a grating-over-grating structure 104 in which multiple periodicities are provided through optical proximity correction (OPC) feature modulation, in accordance with one or more embodiments of the present disclosure. As with FIG. 1D, only the second-layer features 112 on the second layer 114 (e.g., the top layer) of the sample 110 are depicted. In FIG. 1E, the first-layer features 106 and the second-layer features 112 are distributed with a fine pitch P_{fine} and further include additional features 116 (e.g., OPC features) distributed with a coarse pitch P_{coarse}. The additional features 116 may include any combination of positive features (e.g., fabricated features) or negative features (e.g., features defined by holes or gaps such as, but not limited to, the additional features 116). For example, FIG. 1E depicts a configuration in which the additional features 116 are negative features (e.g., holes).

Referring now to FIGS. 1F-1G, a metrology target 102 may include any number of grating-over-grating structures 104 in different cells (e.g., spatial regions), where the cells may optionally be separated by an exclusion zone formed as an unpatterned space or a space patterned with dummy features that do not contribute to a metrology measurement. In this way, an exclusion zone may allow for separability of signals associated with different grating-over-grating structures 104.

In some embodiments, a metrology target 102 may include a first cell including a grating-over-grating structure 104 having periodicities along a first measurement direction (e.g., an X direction) and a second cell including a grating-over-grating structure 104 having periodicities along a second measurement direction (e.g., a Y direction).

FIG. 1F illustrates a top view of a metrology target 102 providing two grating-over-grating structures 104 (e.g., in different cells) with periodicities along different measurement directions, in accordance with one or more embodiments of the present disclosure. In particular, the metrology target 102 in FIG. 1F includes a first grating-over-grating structure 104-1 with periodicity along a horizontal direction in the figure and a second grating-over-grating structure 104-2 with periodicity along a vertical direction in the figure.

FIG. 1G illustrates a top view of a metrology target 102 providing multiple grating-over-grating structures 104 (e.g., in different cells) associated with each measurement direction, in accordance with one or more embodiments of the present disclosure.

As with FIGS. 1D-1E, only the second-layer features 112 are shown in FIGS. 1F-1G for clarity. Further, FIGS. 1F-1G only depicts a single pitch. However, it is to be understood that the first grating-over-grating structure 104-1 and the second grating-over-grating structure 104-2 in FIGS. 1F-1G may each have any common pitch distributions along the respective measurement directions and may have any design such as, but not limited to, the designs depicted in any of FIGS. 1A-1E.

It is contemplated herein that a metrology target 102 with multiple grating-over-grating structures 104 may enable multiple simultaneous metrology measurements. For example, FIGS. 1F-1G depict illumination of the metrology target 102 with an illumination beam 118 having a spot size large enough to interact with both grating-over-grating structures 104. In this configuration, collected light 120 from the metrology target 102 may include zero-order double diffraction from both the first grating-over-grating structure 104-1 and the second grating-over-grating structure 104-2. Further, as will be described in greater detail below, separated or separable measurement data and/or metrology measurements may be generated for the first grating-over-grating structure 104-1 and the second grating-over-grating structure 104-2. It is further contemplated herein that a metrology target 102 with multiple grating-over-grating structures 104 may enable the fabrication of a relatively small metrology target 102, which may ease requirements for placement on a sample 110. For instance, the systems and methods disclosed herein may enable the metrology target 102 to be on the order of 20 micrometers per side or smaller.

Referring generally to FIGS. 1A-1G, the first-layer features 106 and the second-layer features 112 may have the same or different critical dimensions (CDs) or widths.

For example, FIG. 1C depicts a non-limiting configuration in which the first-layer features 106 have larger CDs than the second-layer features 112, which may provide mechanical support for the second-layer features 112, facilitate robust fabrication with relatively low variation, and provide sensitive metrology measurements. For example, the first-layer features 106 have a first CD CD₁ larger than a second CD CD₂ of the second-layer features 112. However, this is merely an illustration and not a requirement.

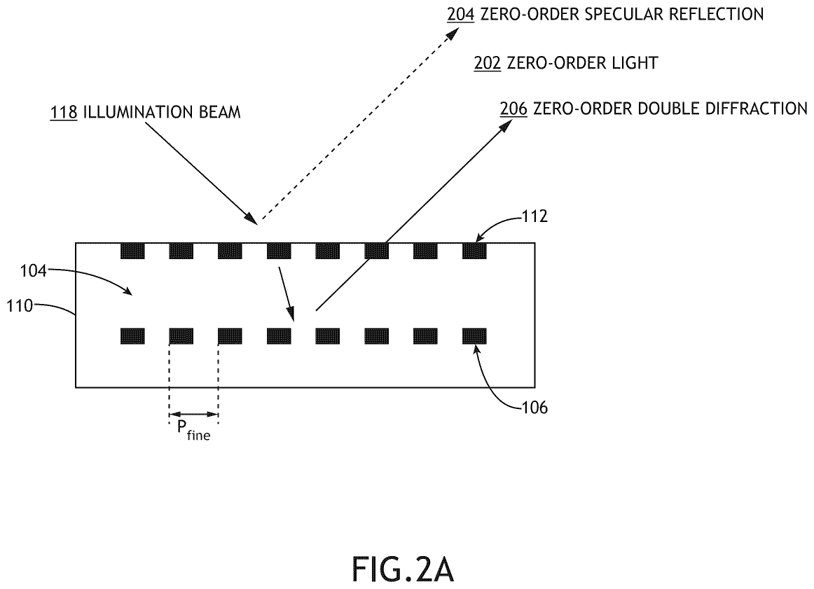

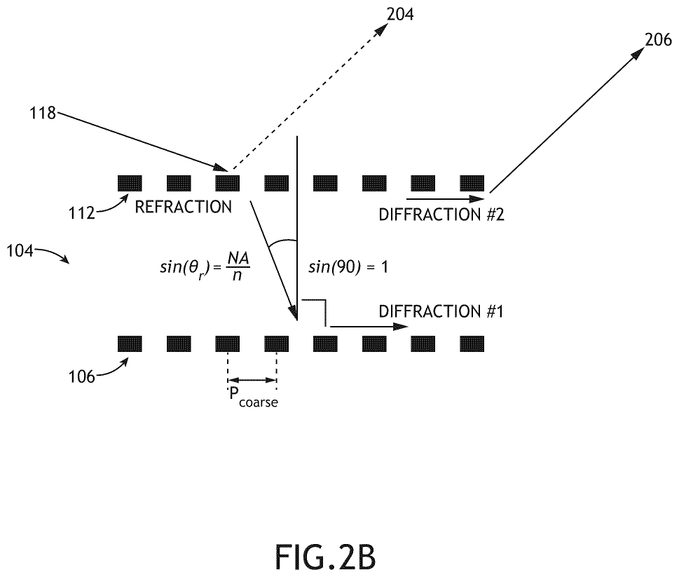

Referring now to FIGS. 2A-2B, coding of metrology data into zero-order double diffraction of an incident illumination beam by the first-layer features 106 and the second-layer features 112 is described in greater detail. The FIGS. 2A-2B may be extended to any design of a grating-over-grating structure 104 including, but not limited to, the designs depicted in FIGS. 1A-1G.

FIG. 2A illustrates zero-order double-diffraction from grating-over-grating structures 104 based on evanescent wave double scattering, in accordance with one or more embodiments of the present disclosure. In particular, FIG. 2A depicts various zero-order light 202 generated in response to an incident illumination beam 118 having an electric field E. For example, FIG. 2A depicts zero-order specular reflection 204 and zero-order double diffraction 206 associated with interaction of the illumination beam 118 with both the first-layer features 106 and the second-layer features 112.

The zero-order double diffraction 206 may correspond to diffraction of opposing signs from the first-layer features 106 and the second-layer features 112 based on evanescent waves. As an illustration, zero-order double diffraction 206 may be generated by +1 diffraction from the second-layer features 112 and −1 diffraction from the first-layer features 106 or −1 diffraction from the second-layer features 112 and +1 diffraction from the first-layer features 106. It is noted that the various arrows in FIG. 2A are intended solely to conceptually illustrate double diffraction, but do not represent precise optical paths.

The conditions for such evanescent wave double scattering may be satisfied when the distance between the first-layer features 106 and the second-layer features 112 is sufficiently small to enable diffraction of evanescent waves. It is contemplated herein that this condition is satisfied for many process layers at an AEI process step. Accordingly, FIG. 2A may describe zero-order double diffraction of grating-over-grating structures 104 with a fine pitch P_{fine} corresponding to a device pitch when the grating-over-grating structures 104 is embodied in an AEI process step.

It is further contemplated herein that this zero-order double diffraction 206 may include “coded” information associated with various properties of the grating-over-grating structures 104 such as, but not limited to, overlay information, asymmetry information, film thickness information, or CD information.

As an illustration considering an overlay measurement, the electric field of these combined signals may be characterized as:

$${E}_{0}^{r} {e}^{i δ} + {E}_{1}^{r} {e}^{i \frac{2 π}{P} O V L} = {E}_{0}^{r} ( cos ( δ ) + i sin ( δ ) ) + {E}_{1}^{r} ( cos ( \frac{2 π}{P} OVL ) + i sin ( \frac{2 π}{P} OVL ) ) = {E}_{0}^{r} cos ( δ ) + {E}_{1}^{r} cos ( \frac{2 π}{P} OVL ) + i ( {E}_{0}^{r} sin ( δ ) + {E}_{1}^{r} sin ( \frac{2 π}{P} OVL ) ) = J {e}^{i ϑ} \cdot {E}^{i} . \qquad ( 1 )$$

In Equation (1), OVL corresponds to overlay (e.g., physical registration between the first-layer features 106 and the second-layer features 112), P corresponds to a pitch of the first-layer features 106 and the second-layer features 112 (e.g., P_{fine} at an AEI process step), and δ corresponds to a difference between first-order topographic phase and zero-order topographic phase of the second-layer features 112. Put another way, δ corresponds to a difference between the electric field associated with zero-order specular reflection 204 and an electric field associated with zero-order double diffraction 206. This δ may include information about the second-layer features 112 such as, but not limited to, critical dimension (CD) information or tilt information. Further, Je^{iδ} corresponds to a response function of the grating-over-grating structures 104 (e.g., a Jones element, or the like).

A value of the overlay OVL may thus be extracted from a captured zero-order signal (e.g., as a metrology measurement). For example, an overlay measurement may be extracted based on fitting of an intensity of zero-order light, where the intensity is modeled based on an electric field such as, but not limited to, that described in Equation (1). Further, although Equation (1) and the above description relate specifically to overlay, additional properties of the grating-over-grating structures 104 or constituent features thereof (e.g., asymmetry properties, film thickness properties, CD properties, or the like) may also be encoded into zero-order light (e.g., as represented by Je^{iδ} in Equation (3)).

In a general sense, the sensitivity of the intensity of zero-order light and thus the intensity or strength of zero-order signals associated with the grating-over-grating structures 104 to any particular physical property of the grating-over-grating structures 104 may depend on the polarization and phase of the illumination beam 118 and/or the zero-order light used for a measurement. In this way, ellipsometry techniques may be used to tune the sensitivity of a measurement to a particular parameter of interest. For example, a measurement sub-system may include polarizers and/or phase-control optics (e.g., waveplates) in a pathway of illumination beams 118 and/or collected zero-order light to tune the sensitivity of a measurement to a particular parameter for a particular metrology measurement.

FIG. 2B illustrates zero-order double-diffraction from grating-over-grating structures 104 for configurations with larger separations between sample layers than depicted in FIG. 2A, in accordance with one or more embodiments of the present disclosure. It is contemplated herein that a grating-over-grating structure 104 embodied at an ADI step may have relatively larger separation between the first-layer features 106 and the second-layer features 112, which may influence the conditions at which zero-order double diffraction encoded with metrology information may be captured.

It is contemplated herein that zero-order double diffraction may be coded with phase information associated with the top and bottom layer features when Equations 2-3 are satisfied:

$$\frac{λ / n}{P} < sin {θ}_{r} + sin 90 = \frac{NA}{n} + 1 \qquad ( 2 )$$

which may be simplified to

$$P > \frac{λ}{n ( 1 + \frac{NA}{n} )} = \frac{λ}{n + NA} , \qquad ( 3 )$$

where P is the feature pitch (e.g., a coarse pitch P_{course}), λ corresponds to a wavelength in an incident illumination beam 118, NA corresponds to a numerical aperture of collected light, n is a refractive index of material between the top layer and the bottom layer, and θᵣ is an internal angle of diffracted light.

Table 1 indicates corresponding minimum pitches that satisfy Equations (2)-(3) based on an incidence angle of an illumination beam 118 of 71 degrees, a NA of 0.94, and a refractive index n between the first-layer features 106 and the second-layer features 112 of 1.6.

| Wavelength (nm) | Pitch (nm) |
|---|---|
| 1000 | 394 |
| 900 | 357 |
| 800 | 315 |
| 700 | 275 |
| 500 | 236 |
| 400 | 197 |
| 300 | 157 |
| 300 | 118 |
| 200 | 79 |
| 150 | 59 |

As shown in Table 1, characterization in an ADI step using visible wavelengths and higher typically require a pitch P to be on the order of 100 nm or higher (e.g., 100-300 nm). Accordingly, in some embodiments, the metrology target 102 includes at least one grating-over-grating structure 104 having features with a coarse pitch P_{coarse} on the order of hundreds of nanometers suitable for characterization in an ADI step and features with a fine pitch P_{fine} on the order of ones or tens of nanometers. However, this is merely an illustration and not limiting on the scope of the present disclosure. For example, the fine pitch may be less than 100 nanometers and the coarse pitch may be greater than 100 nanometers. As another example, the fine pitch is 50 nanometers and the coarse pitch may be 300 nanometers. Such a configuration may be suitable for, but not limited to, ADI metrology measurement based on wavelengths equal to or greater than 400 nanometers and AEI metrology measurement based on wavelengths equal to or greater than 150 nm.

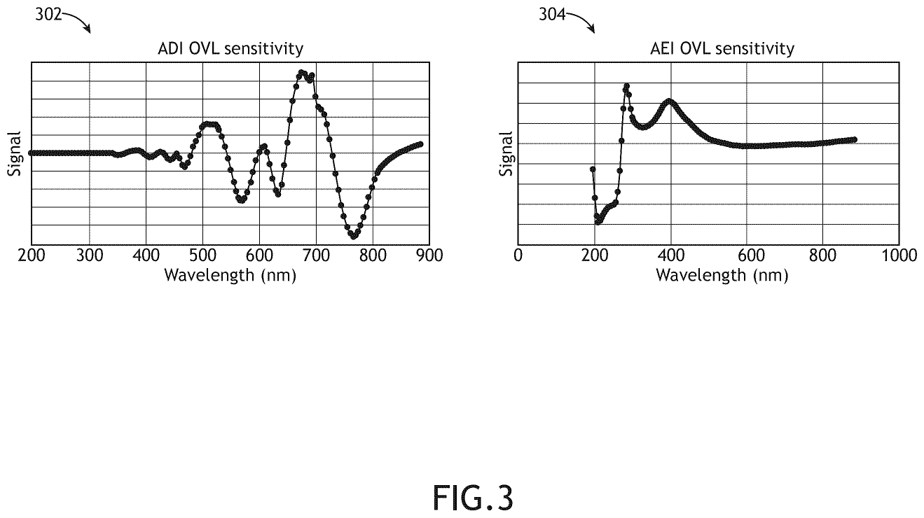

FIG. 3 depicts simulations of overlay sensitivity for a metrology target 102 at different process steps, in accordance with one or more embodiments of the present disclosure. Such dimensions may correspond to a bit-line contact to a word-line layer. In particular, plot 302 depicts overlay sensitivity as a function of wavelength of a metrology target 102 measured at an ADI process step and plot 304 depicts overlay sensitivity as a function of wavelength of the metrology target 102 at an AEI process step. As shown in FIG. 3, different wavelengths or wavelength ranges may be suitable for measurement of the metrology target 102 in different process steps based on the differences in the physical characteristics of the metrology target 102 when embodied at these different process steps.

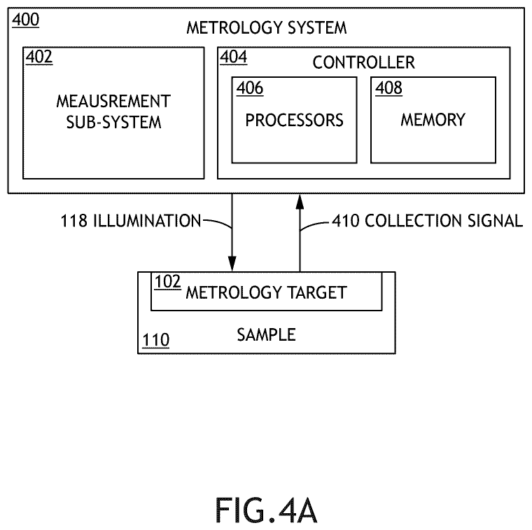

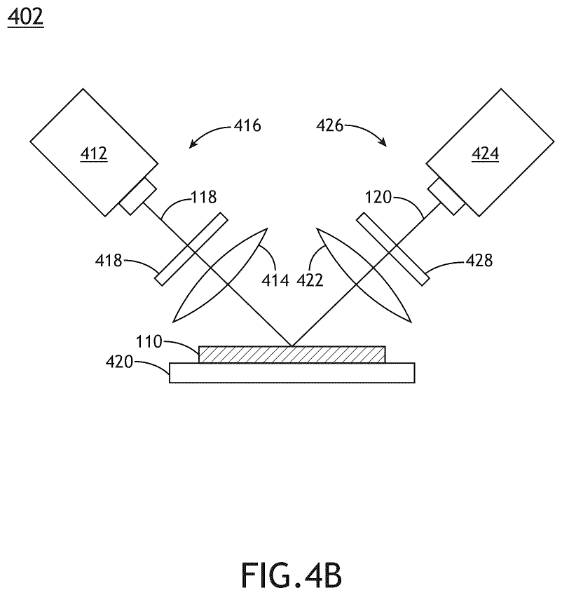

Referring now to FIGS. 4A-4B, a metrology system 400 suitable for characterizing a metrology target 102 is described, in accordance with one or more embodiments of the present disclosure.

FIG. 4A is a block diagram of a metrology system 400 in accordance with one or more embodiments of the present disclosure.

In some embodiments, the metrology system 400 includes a measurement sub-system 402 to generate measurement data associated with a metrology target 102 on a sample 110 and further includes a controller 404 to generate one or more metrology measurements associated with the based on the measurement data. The controller 404 may include one or more processors 406 configured to execute a set of program instructions maintained in a memory 408, or memory device, where the program instructions may cause the processors 406 to implement various actions or steps disclosed herein.

A measurement sub-system 402 may include any components or combination of components suitable for generating measurement data associated with a metrology target 102. For example, a measurement sub-system 402 may direct illumination beam 118 to the metrology target 102, capture a collection signal 410 from the metrology target 102 in response to the illumination beam 118, and generate measurement data based on this collection signal 410 (e.g., with a detector), where the measurement data includes information indicative of one or more metrology measurements of interest.

In some embodiments, a measurement sub-system 402 includes an optical measurement sub-system 402 to generate measurement data based on interaction of the sample 110 with illumination beam 118 including light of any suitable wavelength or combination of wavelengths including, but not limited to, ultraviolet (UV) wavelengths, visible wavelengths, or infrared (IR) wavelengths. For example, an optical measurement sub-system 402 may include, but is not limited to, a spectroscopic ellipsometer (SE), an SE with multiple angles of illumination, an SE measuring Mueller matrix elements (e.g. using rotating compensator(s)), a single-wavelength ellipsometer, a beam profile ellipsometer (angle-resolved ellipsometer), a beam profile reflectometer (angle-resolved reflectometer), a broadband reflective spectrometer (spectroscopic reflectometer), a single-wavelength reflectometer, an angle-resolved reflectometer, an imaging system, a scatterometer (e.g., speckle analyzer), a Raman metrology tool, a laser driven spectroscopic reflectometry (LDSR) system, or any combination thereof.

Further, the measurement sub-system 402 may be configurable to generate metrology measurements based on any number of metrology recipes, where a metrology recipe may define various imaging parameters used to generate measurement data and/or processing techniques to generate metrology measurements from measurement data. For example, a metrology recipe of may include parameters associated with the illumination beam 118 such as, but not limited to, a number of beams, incidence angles (e.g., azimuth and/or polar incidence angles), polarization, phase characteristics, or wavelength. As another example, a metrology recipe may include parameters associated with the collection signal 410 used to generate the measurement data such as, but not limited to, collection angles (e.g., to collect zero-order double diffraction), polarization, phase characteristics, or wavelength. As another example, a metrology recipe may include sampling characteristics such as, but not limited to, locations on a sample 110 to be measured (e.g., locations of dedicated overlay targets or device features to be characterized) or focus characteristics.

The one or more processors 406 of a controller 404 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 406 may include any device configured to execute algorithms and/or instructions (e.g., program instructions stored in memory). In some embodiments, the one or more processors 406 may be embodied as a desktop computer, mainframe computer system, workstation, image computer, parallel processor, networked computer, or any other computer system configured to execute a program configured to operate or operate in conjunction with the measurement sub-systems 402, as described throughout the present disclosure. Moreover, different subsystems of the metrology system 400 may include a processor or logic elements suitable for carrying out at least a portion of the steps described in the present disclosure.

Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 404 may include one or more controllers housed in a common housing or within multiple housings. In this way, any controller or combination of controllers may be separately packaged as a module suitable for integration into metrology system 400.

The memory 408 may include any storage medium known in the art suitable for storing program instructions executable by the associated one or more processors 406.

For example, the memory 408 may include a non-transitory memory medium. By way of another example, the memory 408 may include, but is not limited to, a read-only memory (ROM), a random-access memory (RAM), a magnetic or optical memory device (e.g., disk), a magnetic tape, a solid-state drive and the like. It is further noted that the memory 408 may be housed in a common controller housing with the one or more processors 406.

In some embodiments, the memory 408 may be located remotely with respect to the physical location of the one or more processors 406 and the controller 404. For instance, the one or more processors 406 of the controller 404 may access a remote memory (e.g., server), accessible through a network (e.g., internet, intranet and the like).

FIG. 4B is a simplified schematic of an optical measurement sub-system 402, in accordance with one or more embodiments of the present disclosure. For example, the measurement sub-systems 402 may include, but is not limited to, a spectroscopic metrology tool. However, this is merely illustrative and non-limiting. The optical measurement sub-system may generally include any type of optical measurement sub-system including, but not limited to, a spectral ellipsometer (SE), an SE with multiple angles of illumination, an SE measuring Mueller matrix elements (e.g. using rotating compensator(s)), a single-wavelength ellipsometer, a beam profile ellipsometer (angle-resolved ellipsometer), a beam profile reflectometer (angle-resolved reflectometer), a broadband reflective spectrometer (spectroscopic reflectometer), a single-wavelength reflectometer, an angle-resolved reflectometer, an imaging system, a scatterometer (e.g., speckle analyzer), or any combination thereof. Nonlimiting examples of optical metrology tools within the spirit and scope of the present disclosure are generally described in U.S. Pat. No. 7,478,019 issued on Jan. 13, 2009 and U.S. patent application Ser. No. 18/822,901, both of which are incorporated herein by reference in their entireties.

In some embodiments, the measurement sub-systems 402 includes an illumination source 412 configured to generate at least one illumination beam 118. The illumination beam 118 from the illumination source 412 may include one or more selected wavelengths of light including, but not limited to, ultraviolet (UV) radiation, visible radiation, or infrared (IR) radiation. Further, the spatial profile of the illumination beam 118 on the sample 110 may be controlled by a field-plane stop to have any selected spatial profile.

The illumination source 412 may include any type of illumination source suitable for providing an illumination beam 118. In some embodiments, the illumination source 412 is a laser source. For example, the illumination source 412 may include, but is not limited to, one or more narrowband laser sources, a broadband laser source, a supercontinuum laser source, a white light laser source, or the like. In some embodiments, the illumination source 412 includes a laser-sustained plasma (LSP) source. For example, the illumination source 412 may include, but is not limited to, a LSP lamp, a LSP bulb, or a LSP chamber suitable for containing one or more elements that, when excited by a laser source into a plasma state, may emit broadband illumination. In some embodiments, the illumination source 412 includes a lamp source. In some embodiments, the illumination source 412 may include, but is not limited to, an arc lamp, a discharge lamp, an electrode-less lamp, or the like.

The illumination source 412 may provide the illumination beam 118 using free-space techniques and/or optical fibers.

In some embodiments, the measurement sub-systems 402 directs the illumination beam 118 to the sample 110 through at least one illumination lens 414 (e.g., an objective lens) via an illumination pathway 416. The illumination pathway 416 may include one or more optical components suitable for manipulating and/or conditioning the illumination beam 118 as well as directing the illumination beam 118 to the sample 110. In some embodiments, the illumination pathway 416 includes one or more illumination-pathway optics 418 to shape or otherwise control the illumination beam 118. For example, the illumination-pathway optics 418 may include, but are not limited to, one or more lenses one or more field stops, one or more pupil stops, one or more polarizers, one or more filters, one or more beam splitters, one or more diffusers, one or more homogenizers, one or more apodizers, one or more beam shapers, or one or more mirrors (e.g., static mirrors, translatable mirrors, scanning mirrors, or the like).

The measurement sub-system 402 may position the sample 110 for a measurement using any suitable technique. In some embodiments, as illustrated in FIG. 4B, the measurement sub-systems 402 includes a sample stage 420 including one or more actuators (e.g., linear actuators, tip/tilt actuators, rotational actuators, or the like) to position the sample 110 with respect to the illumination beam. In some embodiments, though not explicitly shown, the measurement sub-system 402 includes beam-scanning optics (e.g., galvanometer mirrors, scanning prisms, or the like) to adjust a position and/or scan one or more beams of illumination beam 118.

In some embodiments, the measurement sub-system 402 includes at least one collection lens 422 to capture collection signal 410 (e.g., light), and direct this collection signal 410 to one or more detectors 424 through a collection pathway 426. The collection pathway 426 may include one or more optical elements suitable for manipulating and/or conditioning the collection signal 410 from the sample 110 prior to the one or more detectors 424. In some embodiments, the collection pathway 426 includes one or more collection-pathway optics 428 to shape or otherwise control the collection signal 410. For example, the collection-pathway optics 428 may include, but are not limited to, one or more lenses one or more field stops, one or more pupil stops, one or more polarizers, one or more filters, one or more beam splitters, one or more diffusers, one or more homogenizers, one or more apodizers, one or more beam shapers, or one or more mirrors (e.g., static mirrors, translatable mirrors, scanning mirrors, or the like).

The measurement sub-system 402 may generally include any number or type of detectors 424. For example, the measurement sub-systems 402 may include at least one single-pixel detector 424 such as, but not limited to, a photodiode, an avalanche photodiode, or a single-photon detector. As another example, the measurement sub-systems 402 may include at least one mutli-pixel detector 424 such as, but not limited to, a charge-coupled device (CCD) or a complementary metal-oxide semiconductor (CMOS) device, a line detector, or a time-delay integration (TDI) detector.

A detector 424 may be located at any selected location within the collection pathway 426. In some embodiments, the measurement sub-system 402 includes a detector 424 at a field plane (e.g., a plane conjugate to the sample 110) to generate an image of the sample 110. In some embodiments, the measurement sub-system 402 includes a detector 424 at a pupil plane (e.g., a diffraction plane) to generate a pupil image. In this regard, the pupil image may correspond to an angular distribution of light from the sample 110 detector 424. For instance, diffraction orders associated with diffraction of the illumination beam 118 from the sample 110 may be imaged or otherwise observed in the pupil plane. In a general sense, a detector 424 may capture any combination of reflected (or transmitted), scattered, or diffracted light from the sample 110.

The illumination pathway 416 and the collection pathway 426 of the measurement sub-systems 402 may be oriented in a wide range of configurations. For example, as illustrated in FIG. 4B, the illumination pathway 416 and the collection pathway 426 may contain non-overlapping optical paths. In some embodiments, though not explicitly shown, the measurement sub-system 402 may include a beamsplitter oriented such that a common objective lens may simultaneously direct the illumination beam 118 to the sample 110 and capture collection signal 410.

The metrology system 400 may generate one or more metrology measurements based on measurement data generated by the detector 424 associated with zero-order double diffraction from the metrology target 102 associated with one or more configurations of the measurement sub-system 402. For example, any particular metrology measurement may be generated based on measurement data associated with one or more configurations of the one or more illumination-pathway optics 418, the one or more collection-pathway optics 428, or any other component of the measurement sub-system 402 in accordance with a metrology recipe. Put another way, measurement data may be generated with any combination of properties of the illumination beam 118 and/or the collection signal 410 such as, but not limited to, polarization, phase, wavelength, or angle (e.g., incidence angle or collection angle). Any particular metrology measurement may then be generated based on one or more sets of measurement data.

The measurement data may include any data generated by the measurement sub-system 402 based on collected zero-order double diffraction from a metrology target 102. As an illustration in the case of a spectral measurement sub-system 402 (e.g., a spectral ellipsometry tool, or the like), the measurement data may correspond to a spectrum of a zero-order light collected by the measurement sub-system 402 in response to illumination with an illumination beam 118. It is to be understood that other types of measurement data associated with other types of measurement sub-systems 402 are within the spirit and scope of the present disclosure.

In some embodiments, the metrology system 400 simultaneously generates metrology data (and optionally associated metrology measurements) from multiple grating-over-grating structures 104 associated with a metrology target 102. Different grating-over-grating structures 104 within a metrology target 102 may be designed to have separable spectra such that separate measurement data and/or metrology measurements may be generated in a single measurement.

Measurement data from multiple grating-over-grating structures 104 may be separated (or designed to be separated) using any suitable technique. For example, measurement data from multiple grating-over-grating structures 104 may be physically separated in the measurement sub-system 402 based on properties of the illumination beam 118 and/or the collection signal 410 such as, but not limited to, polarization or wavelength. As another example, measurement data from multiple grating-over-grating structures 104 may be separated algorithmically (e.g., by the controller 404) using techniques such as, but not limited to, principal component analysis. Separability of measurement data is generally described in U.S. patent application Ser. No. 18/919,048 filed on Oct. 17, 2024 which is incorporated herein by reference in its entirety.

As an illustration, the metrology target 102 illustrated in FIG. 1D may be illuminated with a single illumination beam 118 such that the collection signal 410 may include light associated with zero-order double diffraction from both the first grating-over-grating structure 104-1 and the second grating-over-grating structure 104-2.

Further, the metrology system 400 may generate metrology measurements at one or more steps of a fabrication process. In some embodiments, the metrology system 400 may generate one or more metrology measurements of a metrology target 102 at an ADI step and also one or more metrology measurements of the same metrology target 102 at an AEI step. the metrology system 400 may then further generate an NZO measurement associated with a difference between the metrology measurements at the different process steps.

The metrology system 400 may generate any type of metrology measurement that may be determined at least in part by measurement data associated with zero-order double diffraction from a metrology target 102. For example, a metrology measurement may include, but is not limited to, an overlay measurement, an asymmetry measurement (e.g., a tilt measurement, or the like), a film thickness measurement, or a CD measurement.

In some embodiments, the metrology system 400 generates a metrology measurement at least in part via the controller 404. For example, the one or more processors 406 of the controller 404 may receive measurement data from the measurement sub-system 402 (e.g., from the detector 424) and execute program instructions causing the one or more processors 406 to generate one or more metrology measurements based on the measurement data.

In some embodiments, the metrology system 400 generates metrology measurements using a model that relates measurement data to the metrology measurements.

For example, the measurement model may include a physics-based measurement model. As an illustration, the measurement model may include an electromagnetic solver based on algorithms such as, but not limited to, rigorous coupled-wave analysis (RCWA) techniques, finite element method (FEM) techniques, method of moments techniques, surface integral techniques, volume integral techniques, finite different time domain (FDTD) techniques, or the like. In this configuration, a metrology measurement may be generated by fitting measurement data to the measurement model, where values of the fitted parameters may be related to values of one or more metrology measurements of interest.

As another example, the measurement model may include a machine learning model. The machine learning model may incorporate any type or combination of machine learning techniques such as, but not limited to, supervised machine learning techniques, semi-supervised machine learning techniques, reinforcement machine learning techniques, or unsupervised machine learning techniques. As an illustration, a machine learning model may include, is not limited to, a linear model, a neural network model, a polynomial model, a decision tree model, or a random forest model. In some applications, training data may include a combination of experimental and simulated data.

A machine learning model may accept any type of input data suitable for determining metrology measurements of an instance of a metrology target 102 based on at least one of second measurement data or delta metrics associated with the instance of the metrology target 102.

For example, a machine learning model may accept measurement data (e.g., raw data) associated with a particular measurement configuration. As an illustration, a spectrometry-based optical measurement sub-system 402 may generate signals associated with 15 Mueller matrix elements, with approximately 570 wavelength pixels per signal to provide approximately 10,000 individual signals for a particular measurement configuration. This is merely illustrative, however, and should not be interpreted as limiting the scope of the present disclosure. For example, such a system may generate signals associated with any number of Mueller matrix elements (e.g., up to 16 Mueller matrix elements) and provide any number of datapoints for any number of wavelengths.

As another example, a particular machine learning model may accept principal components (PCs) associated with a subset or a transformation of a measurement dataset associated with a particular measurement configuration. In some embodiments, the controller 404 may extract principal component sets (e.g., features) from measurement data, where the machine learning model generates the metrology measurements based on the principal component sets. In this way, the step of extracting the principal component sets from input measurement data may provide dimensionality reduction of the associated measurement datasets. The principal component sets may correspond to a subset of input data or a transformation of the input data. The step of extracting the principal component sets from the measurement datasets may be implemented using any suitable technique including, but not limited to, a principal component analysis (PCA) (e.g., linear or non-linear) or a fast Fourier Transform (FFT) analysis. In a general sense, the principal component set may correspond to aspects of the associated measurement data that are correlated with the metrology measurements. Further, the metrology target 102 may be designed to provide self-calibration of the measurement data.

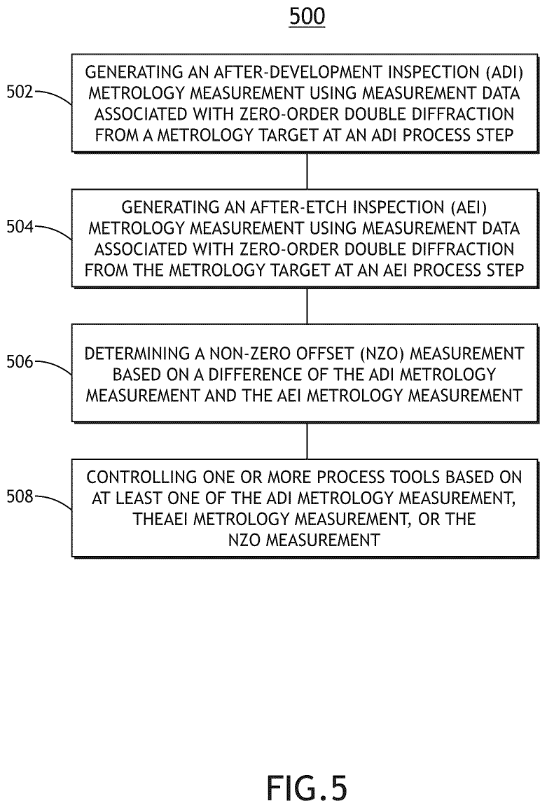

FIG. 5 is a flow diagram illustrating steps performed in a metrology method 500, in accordance with one or more embodiments of the present disclosure. Applicant notes that the embodiments and enabling technologies described previously herein in the context of the metrology system 400 should be interpreted to extend to the metrology method 500. For example, the one or more processors 406 of the controller 404 may implement one or more steps of the metrology method 500 either directly (e.g., algorithmically) or indirectly by generating control signals to control one or more components of the metrology system 400 and/or external components. However, that the method 500 is not limited to the architecture of the metrology system 400.

The metrology method 500 may include a step 502 of generating an ADI metrology measurement using measurement data associated with zero-order double diffraction from a metrology target 102 at an ADI process step. The metrology method 500 may include a step 504 of generating an AEI metrology measurement using measurement data associated with zero-order double diffraction from the metrology target 102 at an AEI process step.

For example, the metrology target 102 may include first-layer features on a first layer 108 of a sample 110 overlapped with second-layer features 112 on a second layer 114 of the sample 110. The first-layer features and the second-layer features may both have one or more common pitches selected to provide the zero-order double diffraction when the metrology target is at both the ADI and AEI process steps. For example, the first-layer features and the second-layer features may have a single pitch characterizable by a common metrology tool (e.g., the metrology system 400) at the ADI and AEI process steps, possibly with different wavelengths or wavelength ranges. As another example, the first-layer features and the second-layer features may have a common coarse pitch designed for measurement at an ADI process step and a common fine pitch suitable for measurement at an AEI process step, where the measurements at the ADI and AEI process steps may be with the same or different wavelengths or wavelength ranges.

In some embodiments, though not explicitly shown in FIG. 5, the method includes a step of designing the metrology target 102 by selecting the one or more common pitches based on a known wavelength range of the metrology tool and known properties of the metrology target 102 when embodied at the ADI and AEI process steps. For example, the known properties of the metrology target 102 when embodied at the ADI and AEI process steps may include, but are not limited to, the number, type, and composition of layers in the metrology target 102 at both the ADI and AEI process steps (e.g., as described with respect to FIGS. 1A-1B). Further, information about the metrology tool such as, but not limited to, the available wavelength range may be further used to guide the selection of the common pitches.

Further, in some embodiments, the ADI and/or AEI measurements are calibrated based on additional measurements (e.g., reference measurements) by an additional metrology tool. As an illustration, the step 504 may include generating an initial ADI and/or AEI metrology measurement using measurement data associated with zero-order double diffraction from the metrology target 102 at the ADI and/or AEI process step and adjusting the initial ADI and/or AEI metrology measurement with calibration data, where the calibration data is generated based measurements of one or more metrology targets (e.g., additional metrology targets) with a reference metrology tool such as, but not limited to, a scanning electron microscope. For example, the calibration data may be generated before operation in a high volume manufacturing (HVM) environment and/or through relatively low-frequency measurements during HVM.

The metrology method 500 may include a step 506 of determining a non-zero offset (NZO) measurement based on a difference of the ADI metrology measurement and the AEI metrology measurement. It is contemplated that the systems and methods disclose herein may enable NZO measurements based on a common metrology target 102 overlay target at multiple process steps (e.g., ADI and AEI process steps), which may mitigate errors associated with differences in sample position between the ADI and AEI measurements.

The metrology method 500 may include a step 508 of controlling one or more process tools based on at least one of the ADI metrology measurement, the AEI metrology measurement, or the NZO measurement. Any type of process tool may be controlled such as, but not limited to, a lithography tool, an etching tool, or a polishing tool.

As an illustration, the step 508 may include generating correctables for controlling the one or more process tools in any combination of a feedback or feedforward control technique. For example, correctables for a feedback control technique generated based on one or more metrology targets 102 on a sample 110 may be used to control process tools for similar process steps in the same or subsequent lots (e.g., to correct for drifts, or the like). As another example, correctables for a feed-forward control technique generated based on one or more metrology targets 102 on a sample 110 may be used to control process tools for subsequent processing steps on the same sample 110 or different simples.

The metrology method 500 may further include updating a sampling plan for future samples based on at least one of the ADI metrology measurement, the AEI metrology measurement, or the NZO measurement. For example, a sampling plan may include locations of metrology targets 102 to be characterized by the metrology system 400.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A metrology system comprising:
an illumination source configured to generate an illumination beam;
a measurement sub-system comprising:
one or more lenses to direct the illumination beam to a sample when implementing a metrology recipe and collect zero-order double diffraction from a metrology target in response to the illumination beam, wherein the metrology target in accordance with the metrology recipe comprises one or more grating-over-grating structures, wherein a particular one of the one or more grating-over-grating structures includes features with one or more common pitches on two sample layers;
a detector to capture the zero-order double diffraction; and
at least one of one or more polarizers or one or more phase control optics to manipulate at least one of the illumination beam or the zero-order double diffraction in accordance with the metrology recipe; and
a controller including one or more processors configured to execute program instructions causing the one or more processors to implement the metrology recipe by:
generating an after-develop inspection (ADI) metrology measurement of the metrology target at an ADI process step based on ADI measurement data from the measurement sub-system generated at the ADI process step;
generating an after-etch inspection (AEI) metrology measurement of the metrology target at an AEI process step based on using AEI measurement data from the measurement sub-system generated at the AEI process step;
determining a non-zero offset (NZO) measurement based on a difference of the ADI metrology measurement and the AEI metrology measurement; and
controlling one or more process tools based on at least one of the ADI metrology measurement, the AEI metrology measurement, or the NZO measurement.

2. The metrology system of claim 1, wherein the program instructions further cause the one or more processors to generate an update of a sampling plan for future samples based on at least one of the ADI metrology measurement, the AEI metrology measurement, or the NZO measurement.

3. The metrology system of claim 1, wherein the ADI measurement data is based on wavelengths equal to or greater than 400 nanometers, wherein the AEI measurement data is based on wavelengths equal to or greater than 150 nm.

4. The metrology system of claim 1, wherein the ADI measurement data is based on wavelengths equal to or greater than 700 nanometers, wherein the AEI measurement data is based on wavelengths equal to or greater than 150 nm.

5. The metrology system of claim 1, wherein the ADI measurement data is based on wavelengths equal to or greater than an absorption region of a material in the metrology target at the ADI process step, wherein the AEI measurement data is based on wavelengths equal to or less than the absorption region.

6. The metrology system of claim 1, wherein the metrology target in accordance with the metrology recipe includes at least one of the one or more grating-over-grating structures having a fine pitch and a coarse pitch on each of the two sample layers, wherein the measurement sub-system is configured in accordance with the metrology recipe to generate the ADI measurement data based on the zero-order double diffraction associated with the coarse pitch and generate the AEI measurement data based on the zero-order double diffraction associated with the fine pitch.

7. The metrology system of claim 6, wherein the fine pitch is less than 100 nanometers, wherein the coarse pitch is greater than 100 nanometers.

8. The metrology system of claim 6, wherein the fine pitch is 50 nanometers, wherein the coarse pitch is 300 nanometers.

9. The metrology system of claim 6, wherein the fine pitch is associated with segmentation of the coarse pitch.

10. The metrology system of claim 6, wherein the coarse pitch is associated with modulation of widths of features with the fine pitch.

11. The metrology system of claim 6, wherein the coarse pitch is associated with optical parameter correction (OPC) features.

12. The metrology system of claim 6, wherein the one or more grating-over-grating structures of the metrology target comprise:
one or more first grating-over-grating structures with a first fine pitch and a first coarse pitch along a first measurement direction; and
one or more second grating-over-grating structures with a second fine pitch and a second coarse pitch along a second measurement direction, wherein the measurement sub-system generates the ADI measurement data and the AEI measurement data by simultaneously illuminating the one or more first grating-over-grating structures and the one or more second grating-over-grating structures with the illumination beam, wherein the ADI metrology measurement and the AEI metrology measurement correspond to both the first measurement direction and the second measurement direction.

13. The metrology system of claim 12, wherein the first fine pitch, the second fine pitch, the first coarse pitch, and the second coarse pitch are selected to provide that the zero-order double diffraction associated with the one or more first grating-over-grating structures is separable by the controller from the zero-order double diffraction from the one or more second grating-over-grating structures.

14. The metrology system of claim 1, wherein the metrology target in accordance with the metrology recipe includes one of the one or more grating-over-grating structures having single common pitch on each of the two sample layers, wherein the measurement sub-system is configured in accordance with the metrology recipe to generate the ADI measurement data using a first spectrum of the illumination beam and generate the AEI measurement data with a second spectrum of the illumination beam, wherein the second spectrum of the illumination beam includes one or more wavelengths smaller than the first spectrum.

15. The metrology system of claim 1, wherein the one or more process tools comprise:
at least one of a lithography tool, an etching tool, or a polishing tool.

16. The metrology system of claim 1, wherein the measurement sub-system comprises:
at least one of an ellipsometer, a reflectometer, or a scatterometer.

17. The metrology system of claim 1, wherein the measurement sub-system comprises:
a spectral ellipsometer.

18. The metrology system of claim 1, wherein at least one of the ADI metrology measurement or the AEI metrology measurement is calibrated based on measurement data of one or more measurements of additional metrology targets with an additional metrology tool.

19. The metrology system of claim 18, wherein the additional metrology tool comprises a scanning electron microscope.

20. A metrology method comprising:
generating, with a measurement sub-system including one or more lenses to direct illumination to a metrology target and collect zero-order light from the metrology target, an after-develop inspection (ADI) metrology measurement using ADI measurement data associated with zero-order double diffraction from the metrology target at an ADI process step, wherein the metrology target comprises one or more grating-over-grating structures, wherein a particular one of the one or more grating-over-grating structures includes features with one or more common pitches on two sample layers;
generating, with the measurement sub-system, an after-etch inspection (AEI) metrology measurement using AEI measurement data associated with zero-order double diffraction from the metrology target at an AEI process step;
determining a non-zero offset (NZO) measurement based on a difference of the ADI metrology measurement and the AEI metrology measurement; and
controlling one or more process tools based on at least one of the ADI metrology measurement, the AEI metrology measurement, or the NZO measurement.

21. The metrology method of claim 20, wherein at least one of the ADI metrology measurement or the AEI metrology measurement is calibrated based on measurement data of one or more measurements of additional metrology targets.

22. The metrology method of claim 20, further comprising:
updating a sampling plan for future samples based on at least one of the ADI metrology measurement, the AEI metrology measurement, or the NZO measurement.

23. The metrology method of claim 20, wherein the ADI measurement data is based on wavelengths equal to or greater than 400 nanometers, wherein the AEI measurement data is based on wavelengths equal to or greater than 150 nm.

24. The metrology method of claim 20, wherein the ADI measurement data is based on wavelengths equal to or greater than 700 nanometers, wherein the AEI measurement data is based on wavelengths equal to or greater than 150 nm.

25. The metrology method of claim 20, wherein the ADI measurement data is based on wavelengths equal to or greater than an absorption region of a material in the metrology target at the ADI process step, wherein the AEI measurement data is based on wavelengths equal to or less than the absorption region.

26. The metrology method of claim 20, wherein the metrology target includes at least one of the one or more grating-over-grating structures having a fine pitch and a coarse pitch on each of the two sample layers, wherein the ADI measurement data is associated with the coarse pitch and the AEI measurement data is associated with the fine pitch.

27. The metrology method of claim 26, wherein the fine pitch is less than 100 nanometers, wherein the coarse pitch is greater than 100 nanometers.

28. The metrology method of claim 26, wherein the fine pitch is 50 nanometers, wherein the coarse pitch is 300 nanometers.

29. The metrology method of claim 26, wherein the fine pitch is associated with segmentation of the coarse pitch.

30. The metrology method of claim 26, wherein the coarse pitch is associated with modulation of widths of features with the fine pitch.

31. The metrology method of claim 26, wherein the coarse pitch is associated with optical parameter correction (OPC) features.

32. The metrology method of claim 20, wherein controlling the one or more process tools based on at least one of the ADI metrology measurement, the AEI metrology measurement, or the NZO measurement comprises:
controlling at least one of a lithography tool, an etching tool, or a polishing tool based on at least one of the ADI metrology measurement, the AEI metrology measurement, or the NZO measurement.

33. The metrology method of claim 20, wherein the measurement sub-system comprises:
at least one of an ellipsometer, a reflectometer, or a scatterometer.

34. The metrology method of claim 20, further comprising:
designing the metrology target by selecting the one or more common pitches based on a known wavelength range of the measurement sub-system and one or more known properties of the metrology target at the ADI process step and the AEI process step.

35. A metrology target comprising:
one or more grating-over-grating structures, wherein a particular one of the one or more grating-over-grating structures comprises:
first-layer features on a first layer of a sample; and
second-layer features on a second layer of the sample overlapped with the first-layer features, wherein the first-layer features and the second-layer features have one or more common pitches, wherein the one or more common pitches are selected in accordance with a metrology recipe to provide that zero-order double diffraction from the first-layer features and the second-layer features is measurable when the metrology target is embodied at an after-develop inspection (ADI) process step by a metrology tool and are further selected in accordance with the metrology recipe to provide that zero-order double diffraction from the first-layer features and the second-layer features is measurable when the metrology target is embodied at an after-etch inspection (AEI) process step by the metrology tool.

36. The metrology target of claim 35, wherein the one or more common pitches comprise a fine pitch and a coarse pitch, wherein the coarse pitch is selected in accordance with the metrology recipe to provide that the zero-order double diffraction from the first-layer features and the second-layer features is measurable when the metrology target is embodied at the ADI process step by the metrology tool, wherein the fine pitch is selected in accordance with the metrology recipe to provide that the zero-order double diffraction from the first-layer features and the second-layer features is measurable when the metrology target is embodied at the AEI process step by the metrology tool.

37. The metrology target of claim 36, wherein the fine pitch is less than 100 nanometers, wherein the coarse pitch is greater than 100 nanometers.

38. The metrology target of claim 36, wherein the fine pitch is 50 nanometers, wherein the coarse pitch is 300 nanometers.

39. The metrology target of claim 36, wherein the fine pitch is associated with segmentation of the coarse pitch.

40. The metrology target of claim 36, wherein the coarse pitch is associated with modulation of widths of the first-layer features and the second-layer features.

41. The metrology target of claim 36, wherein the coarse pitch is associated with optical parameter correction (OPC) features.

42. The metrology target of claim 36, wherein the one or more grating-over-grating structures of the metrology target comprise:
one or more first grating-over-grating structures with a first fine pitch and a first coarse pitch along a first measurement direction; and
one or more second grating-over-grating structures with a second fine pitch and a second coarse pitch along a second measurement direction.

43. The metrology target of claim 42, wherein the first fine pitch, the second fine pitch, the first coarse pitch, and the second coarse pitch are selected to provide that the zero-order double diffraction associated with the one or more first grating-over-grating structures is separable from the zero-order double diffraction from the one or more second grating-over-grating structures.

44. The metrology target of claim 35, wherein the one or more common pitches comprise a single common pitch, wherein the single common pitch is selected in accordance with the metrology recipe to provide that the zero-order double diffraction from the first-layer features and the second-layer features is measurable when the metrology target is embodied at the ADI process step by the metrology tool using a first wavelength, wherein the single common pitch is selected in accordance with the metrology recipe to provide that the zero-order double diffraction from the first-layer features and the second-layer features is measurable when the metrology target is embodied at the AEI process step by the metrology tool using a second wavelength.
